(19) United States
(12) Patent Application Publication
(10) Pub. No.: US 2009/0206683 A1
(43) Pub. Date: Aug. 20, 2009

(54) Linear Electric Motors

(76) Inventors: Graham Mead, Buckinghamshire (GB); Eric Madraszek, Buckinghamshire (GB)

Correspondence Address: DAY PITNEY LLP;ACCOUNT: ILLINOIS TOOL WORKS INC., 7 TIMES SQUARE, NEW YORK, NY, 10036-7311, US

(21) Appl. No.: 12/225,893

(22) PCT Filed: Apr. 5, 2007
(86) PCT No.: PCT/IB2007/000905

§ 371 Date: Mar. 18, 2009

(30) Foreign Application Priority Data
Apr. 6, 2006 (GB) 0606972.8

(51) Int. Cl. H02K 41/02

(52) U.S. Cl. 310/12.31

(57) ABSTRACT

A linear electric motor comprises an electromagnetic piston and cylinder device comprising a plurality of stator coils disposed side by side around an axis and wound so as to create a radial magnetic field which alternates its polarity along the length of the axis, when energised, an armature located within the stator and moveable in a direction co-axial with the axis of the stator, and a bearing arrangement for supporting the armature for reciprocation with respect to the stator, characterised in that the bearing arrangement comprises non-magnetic material.

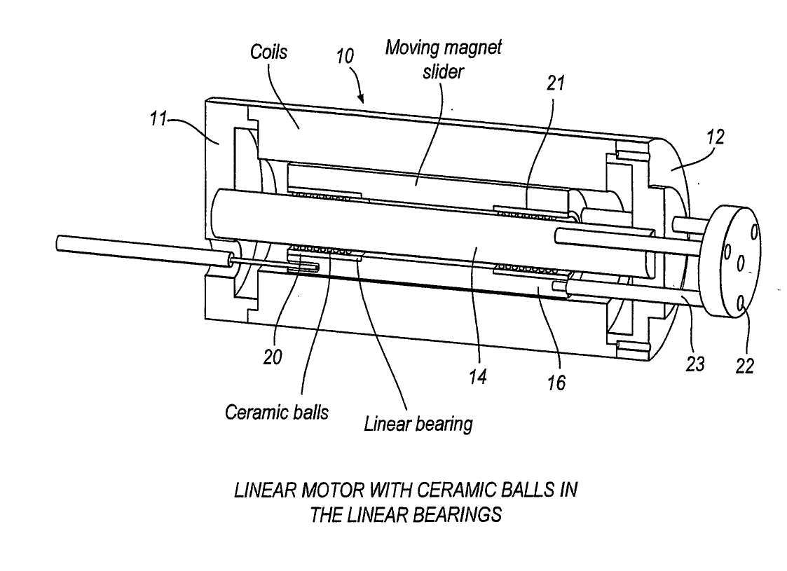

The present invention relates to linear electric motors.

Linear electric motors have been known for a number of years and one such motor takes the form of a piston and cylinder device such as the one disclosed in GB-A-1308349 which comprises a tubular stator of magnetic material having radial polarisation and defining an air gap with a moveable armature coil disposed in the air gap for axial movement.

Such electric motors are used to replace hydraulic piston cylinder devices in many applications. However, when used with light loads and where they are required to accurately reproduce a specific operational force profile, problems arise.

It is an object of the present invention to provide an electromagnetic linear motor in the form of a piston and cylinder device which overcomes the problems of previous such devices.

The present invention provides an electromagnetic piston and cylinder device comprising a plurality of stator coils disposed side by side around an axis and wound so as to create a radial magnetic field which alternates its polarity along the length of the axis, when energised, an armature located within the stator and moveable in a direction co-axial with the axis of the stator, and a bearing arrangement for supporting the armature for reciprocation with respect to the stator, characterised in that the bearing arrangement comprises non-magnetic material.

Preferably, the bearing comprises ceramic material which may be in the form of ceramic ball bearings.

In order that the present invention be more readily understood, an embodiment thereof will now be described by way of example with reference to the accompanying drawing which shows a diagrammatic cross-section through an electromagnetic device.

The preferred embodiment of the present invention is an electric linear motor whose stator is configured to produce a radial magnetic field and whose armature constitutes a piston-like member which is axially moveable in the magnetic field.

As shown in the drawing, the stator comprises a tubular cylinder of circular cross section made up of a cylindrical portion 10 having open ends which are closed by end caps 11 and 12. The cylindrical portion 10 includes a series of coils which are disposed side by side and wound so that when energised by current passing through them, they will produce radial magnetic fields axially disposed along the length of the cylindrical portion. The coils also define an annular air gap with a mandrel 14 whose ends are located in the end caps 11 and 12.

A tubular armature 16 is located in the air gap and includes a series of magnetic assemblies. The magnetic assemblies are preferably in the form of permanent magnets provided with pole pieces so as to create a series of alternating poles along the length of the armature for cooperation with the radial magnetic fields created by the stator coils.

The armature is slidable on the mandrel 14 by virtue of bearings 20 and 21 which will be described in more detail. Movement of the armature is transmitted to an output assembly in the form of a plunger 22 which is connected to the armature by means of one or more rods 23 which project from one end of the armature 16 through apertures in the end cap 12. The rods are located off-axis.

In operation, when the stator coils are energised by an alternating polarity current, a travelling magnetic wave is created in the air gap and this causes the armature to move. We have discovered that when the arrangement described above is used as a force device, the motor will not accurately reproduce an input waveform particularly when applying low forces to an object under test. As a result, a number of investigations were undertaken and it was decided to remove any seals between the rod or rods 23 and the end cap 12. Further, attention was given to the bearings 20 and 21 because of their position within the magnetic fields created by the stator. Initially the highest quality conventional ball bearings of bearing races were utilised but this was found still to be inadequate in order to solve the problem. Surprisingly, it was found that by replacing the conventional high quality ball races with a non-magnetic material ball such as that made from a ceramic material, the desired improvements could be achieved. In other words, by simply replacing the steel ball bearings by non-magnetic material ball bearings such as ceramic ball bearings the problem could be solved. It is possible to also replace completely the ball races as well as the ball bearings themselves with non-magnetic materials such as ceramics.

Although the above-described embodiment utilises stator coils with a permanent magnetic armature, it is possible to change the electromagnetic structure such that the armature can also be constructed utilising coils in addition to the stator. Alternatively, the stator may be constructed from permanent magnets rather than the armature.

1. An electromagnetic piston and cylinder device comprising a plurality of stator coils disposed side by side around an axis and wound so as to create a radial magnetic field which alternates its polarity along the length of the axis, when energised, an armature located within the stator and moveable in a direction co-axial with the axis of the stator, and a bearing arrangement for supporting the armature for reciprocation with respect to the stator, characterised in that the bearing arrangement comprises non-magnetic material.

2. A device according to claim 1, wherein the bearing comprises ball bearings of non-magnetic material.

3. A device according to claim 2, wherein the ball bearings are made of ceramic material.

4. A device according to claim 1, where a mandrel is provided and the armature is tubular and is arranged to reciprocate on the mandrel, the bearing arrangement being between the armature and mandrel.

5. A device according to claim 4, wherein one or more rods are provided in one end of the armature and project through an end cap of the device.
